(19) United States
(12) Patent Application Publication
(10) Pub. No.: US 2021/0064969 A1
(43) Pub. Date: Mar. 4, 2021

(54) METHOD FOR DETECTING A DETERIORATION IN A NETWORK

(71) Applicant: Robert Bosch GmbH, Stuttgart (DE)

(72) Inventors: Christopher Huth, Leonberg (DE); Marcel Kneib, Stuttgart (DE)

(21) Appl. No.: 16/896,778

(22) Filed: Jun. 9, 2020

(30) Foreign Application Priority Data
Aug. 27, 2019 (DE) 102019212825.4

(51) Int. Cl. G06N 3/04; H04L 12/40; G06N 3/08

(52) U.S. Cl. CPC G06N 3/0472; H04L 12/40; H04L 63/14; H04L 2012/40215; H04L 2012/40273; G06N 3/08

(57) ABSTRACT

A method for detecting a deterioration of network components in a network. The method includes the evaluation, in an evaluation unit, of at least one ascertained signal parameter of a signal that is transmitted in a network, in order to determine a signal quality of the signal, and establishing that a deterioration of the network exists if the signal quality lies outside a predefined range.

### CROSS REFERENCE

The present application claims the benefit under 35 U.S.C. § 119 of German Patent Application No. DE 102019212825.4 filed on Aug. 27, 2019, which is expressly incorporated herein by reference in its entirety.

### FIELD

The present method relates to a method for detecting a deterioration of network components in a network and to a processing unit and a computer program for its execution.

### BACKGROUND INFORMATION

To achieve a certain security in the transmission of messages and signals in a network, it is desirable to have the ability to unequivocally authenticate the transmitter and to prevent an unauthorized modification of the transmitted signals along the transmission path.

In the field of network technology, different measures are generally used for this purpose, e.g., the use of signatures or MAC (Message Authentication Code).

However, not all of these measures can be used in a meaningful way in every network. For example, some systems are subject to limitations with regard to the signal size or message size, or the resources for the processing in real time may be limited.

One example in this context are bus systems in vehicles. A common standard for a vehicle bus is the CAN bus, Controller Area Network, which is designed for a rapid communication between microcontrollers and devices in the system without a host computer. The CAN bus protocol is a message-based protocol on a serial bus line, which was originally developed to reduce the connections specifically in vehicles, but is also used in many other fields.

As progress is made in the field of networked and autonomous vehicles, a secure communication plays an ever more important role, in particular in vehicles. It has been shown that vehicle controls are attackable, in particular if the systems have a connection to the outside, e.g., through mobile communications interfaces. Because of the lacking authentication measures on the bus, it is relatively easy to introduce additional or falsified messages from outside without being detected. In particular because safety-critical functions such as brake functions are also controlled via these controls and bus systems, the possibility of an attack from the outside poses a particular problem.

One easy option for detecting an attack is to check the contents and regularity of the messages on the vehicle bus because many messages in this environment are constant or easily predictable and are frequently transmitted in a periodic manner.

Nevertheless, weak spots remain that such a system is unable to detect or prevent. Since messages in the CAN bus system do not include any information about the transmitter, it cannot be ensured that the message does indeed come from a legitimate unit, and if faulty messages or messages identified as an attack are introduced into the network via one of the transmitter units, it is virtually impossible to identify the compromised unit.

For this reason, German Patent Application No. DE 10 2017 208 547 A1 describes the use of a type of physical “fingerprint” of the network or of individual network components for protection purposes. Here, unique properties of the network nodes in the network or of its transmitted signals are utilized to identify the transmitter so that slipped-in messages are able to be identified based on these signal properties. As soon as it is detected with a high degree of probability that none of the known components could be the transmitter of the message and an attack must be assumed, appropriate countermeasures are able to be taken such as the output or emission of a warning signal, the transmission of an error report on the bus or blocking of the relevant message.

For instance, the clock pulse offset that occurs in the clock frequencies of clock pulse generators of the transmitters as a result of tolerances and statistical variations may be used for this purpose. Each transmitter in the bus system therefore exhibits a specific clock pulse offset, i.e., an invariable frequency deviation from a reference frequency.

In the same way, it is also possible to use additional signal parameters as fingerprint parameters. Among these are, for instance, the stability of the signal, in particular in the area of the rising and falling signal edges, or the steepness of the signal edges. There, too, small, transmitter-specific and reproducible deviations can be found that allow for an identification.

The fingerprint parameters may initially be acquired and specified by suitable test messages or be learned through suitable machine learning methods, so that it is known in the system which parameter is associated with which transmitter. The classification of the measured bus signals may then be carried out on a statistical basis, so that if a probability lies above a certain threshold value, the allocation to the matching transmitter takes place.

If signal fingerprints or uniquely identifiable properties of the signals are now used to achieve an attack detection and an identification of the message source in the network, changes in these signals may still occur over time on account of ageing of the network components such as cables, transmitters, receivers, and electronic circuits, but also due to dirt or water in the area of the components or by a physical action of force. Such influences play a particularly important role in vehicles because protection from external effects is realizable only to a limited extent. As a result, for example, interference, resonances and interruptions in the signals or changes in the time characteristics, voltages and currents may occur. Such interference is therefore able to interfere with the reliable function of the transmitter identification or an attack detection using the signal fingerprint. As a matter of principle, however, it is also desirable to detect ageing or damage to the network in a timely manner, for instance in order to request an early exchange of the components before a complete malfunction of the particular function occurs.

### SUMMARY

According to the present invention, an example method is provided for detecting a deterioration of the signal quality in a network as well as a processing unit and a computer program for its execution. Advantageous further embodiments are of the present invention are described herein.

An example embodiment of the present invention uses at least one ascertained signal parameter of a signal which is transmitted within the network. This signal parameter is evaluated either locally or in a remote evaluation unit in order to determine a signal quality of the signal, and if the signal quality lies outside a predefined range, it is established that a deterioration of the network is present. Preferably, the signal parameter is likewise ascertained within the framework of the present invention but may also be supplied from other sources or units, e.g., be externally supplied.

A mathematical model of the network, in particular, may be used for the evaluation, which at least partly describes transmitted signals in the network. At least one modeled signal parameter may then be obtained from such a model, which is compared with the ascertained signal parameters in each case so that the signal quality is able to be determined on the basis of the comparison. Such models are producible by conventional method such as illustrated in great detail in “Simulation of CAN bus physical layer using SPICE”, IEEE International Conference on Applied Electronics, 2013.

For example, the following parameters of a signal are possible as measured, acquired or ascertained signal parameters: a clock pulse offset of a signal, a signal jitter, an edge steepness of a rising or falling signal edge, fluctuations in a signal voltage, a frequency component of a signal, or a bit length of a signal.

The utilized network model, for example, may include a machine learning algorithm, a neural network, a stochastic model, or a data-based model, especially all conventional methods for an outlier detection (also known as an anomaly detection) such as the hidden Markov model, local outlier factor, Bayesian networks and many more. On the basis of the ascertained signal parameters, it is then optionally also possible to modify the network model so that the changes are learned.

In addition to a direct evaluation of the signal parameters, it is also possible to form a signal quality value from individual parameters on the basis of a plurality of ascertained signal parameters of a signal and/or a plurality of ascertained signal parameters of multiple signals from the same source, e.g., the same transmitter, and this signal quality value is able to be used for determining a signal quality of the signal. In the same way, different signal quality values may be formed that take different quality conditions into account or that are formed as a function of a transmitter, for instance.

If a deterioration of the network has been detected through these evaluations, then a warning signal is able to be output, e.g., an acoustical or visual signal in the vehicle to the driver, which suggests a visit to a repair shop, and/or a signal to an interface so that the user receives a message on a mobile device that informs him of the problems, and/or an error entry.

In addition to the evaluation of the signal quality, it is possible to determine on the basis of the at least one signal parameter and the network model which transmitter in the network has sent the signal from which the least one evaluated signal parameter was ascertained. In this way, for example, it can be determined whether a certain bus user exhibits the deterioration and the problem is able to be isolated.

If the transmitter of a signal is known in this way, for instance by the use of signal fingerprints or transmitter-specific characteristics, then it is possible to selectively evaluate signals from at least two different transmitters in the network with regard to their signal quality.

Another option consists of statistically analyzing the signal quality of signals in at least two different networks, with the networks having at least partly identical network characteristics. For example, this may involve network signals in the vehicle buses of different vehicles of the same type or of the same bus system, so that additional findings about the ageing or the deterioration of the component are able to be obtained from the statistical central analysis. These may then in turn be used to form the basis of a better prediction model for the analyzed vehicles.

For example, such methods are able to be used in a controller area network bus (CAN bus) in a vehicle. These networks are safety-critical and must transmit messages without time delay because these messages may involve control commands within the vehicle (e.g., to the brake system). In addition, damage and contamination occur relatively often.

A processing unit according to the present invention such as an electronic control unit of a vehicle is designed, in particular in terms of programming technology, to carry out a method according to the present invention either completely or partly.

The implementation of a method according to the present invention in the form of a computer program or a computer program product having program code for executing all method steps is also advantageous because it is particularly cost-effective, especially when an executing control unit is additionally also used for other tasks and thus is available as it is. Suitable data carriers for supplying the computer program in particular are magnetic, optical and electric memories such as hard disks, flash memories, EEPROMs, DVDs and many more. A download of a program via computer networks (Internet, intranet, etc.) is another option.

Additional advantages and further developments of the present invention result from the description herein and the figures.

The present invention is schematically illustrated in the figures on the basis of exemplary embodiments and is described below with reference to the figures.

### BRIEF DESCRIPTION OF THE DRAWINGS

FIG. 1 shows by way of example, a system in which specific embodiments of the present invention are able to be used.

FIG. 2 shows an exemplary flow diagram for specific embodiments of the present invention.

### DETAILED DESCRIPTION OF EXAMPLE EMBODIMENTS

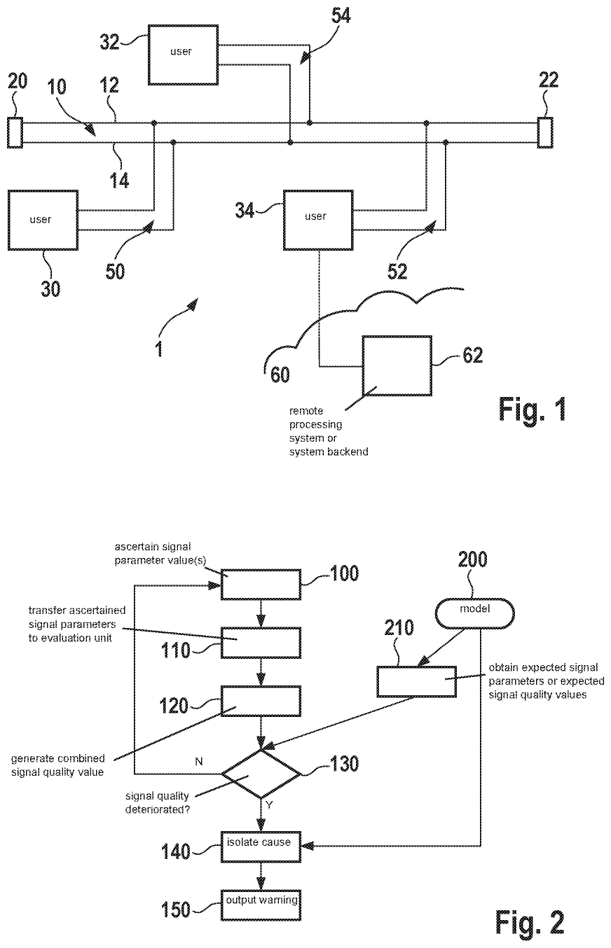

FIG. 1 shows an exemplary system in which embodiments of the present invention are able to be used. The system includes a network 1, which has a bus line 10 provided with terminating resistors 20, 22 at its ends. A plurality of users 30, 32, 34, which are also termed nodes, may be connected to the bus, in particular a plurality of electronic control units (ECU) in the case of a vehicle bus, which are able to control different associated modules such as actuators and sensors in the vehicle and thus are able to assist in a variety of tasks, from the brake systems to positioning systems to engine control functions.

A multitude of users, often 5 to 10 elements per bus line 10, are able to be connected to a bus line. Each network user 30, 32, 34 includes at least one corresponding control unit and a transceiver or transmitter/receiver, which is able to transmit and receive signals on the bus.

In this instance, a CAN bus system (controller area network) having a corresponding protocol is described as an example, but the employed method steps are also transferrable to other networks and protocols.

Bus line 10 includes two signal conductors 12, 14 on which a differential binary signal with a non-return-to-zero code is transmitted. According to the CAN bus protocol, all bus users have essentially equal priorities, i.e., they can transmit messages on the bus at any time, and collisions are avoided by a bitwise arbitration. Bus users 30, 32, 34 are connected via their respective transceiver on stub lines 50, 52, 54 to the two signal conductors 12, 14 (CAN high/CAN low).

One of the users 30, 32, 34 connected to the bus may include a hardware-based and/or software-based module, which is able to acquire and evaluate physical properties or parameters of the signals transmitted on the bus system in an analog and/or digital manner. Such a unit may specifically be provided only for the parameter measurement or it may also assume further control tasks or be connected to other components. In particular, such a module may be set up for an attack detection system on the basis of a signal fingerprint as previously described.

Such physical signal parameters are able to be ascertained on a regular basis and be transmitted to an evaluation unit, e.g., to a processing unit in the network, in another area of the vehicle or also to a remote processing unit or a system backend 62, which is able to evaluate the data and models for a multitude of bus systems 1. For this purpose, a gateway element 34 may be provided as a bus user or network node, which enables a connection to a network 60 or a plurality of networks 60 via corresponding interfaces. These may involve additional parallel vehicle buses, which are separated according to functions, for instance, or also involve external networks such as a WLAN network, or an access to the Internet via a mobile radio connection, etc.

There, the parameters may also be used for keeping a model of the bus architecture updated on an electrical/electronic level, for example.

For instance, signal parameters may be used that allow an inference about the current signal quality such as the signal-to-noise ratio of the signal, the edge steepness or signal reflections. Additional signal parameters are possible as well. These parameters are able to be individually evaluated and provide information about the quality, or a quality value for signals on the particular bus may be derived from at least one parameter, and preferably from a plurality of such parameters. Such monitoring of the signal quality makes it possible to discover existing or looming protocol infringements of the transmission protocol. For example, the time characteristic of the formed signal quality value is able to be evaluated toward this end, or an increase in this value.

Preferably, the monitored signal parameters may at least partly involve parameters that are used for implementing the signal fingerprint identification, which thus are specific to the signals from a certain source. The parameters suitable for such a function usually remain stable in the long term but may nevertheless be affected by damage and ageing effects.

In order to further improve the detection of deviations attributable to damage or ageing, it is also possible to remotely collect and evaluate data from a multitude of vehicles centrally in the evaluation unit, in particular in a central backend. In this way, type-specific changes are able to be evaluated and modeled, for instance when a certain error occurs especially often in a certain vehicle type or when deviations in the signal quality that are classifiable as harmless and are therefore not meant to trigger an error signal occur in certain vehicle types. In the same way, it is possible to continually track and analyze the age-related deterioration. The collected data may be further processed for this purpose, e.g., with the aid of statistical methods, so that the findings obtained across a long period of time may be considered in later bus architectures or in changes in the models.

If a problem was detected based on the physical characteristics, then a more detailed analysis is able to be carried out in order to identify the reason for the deviations. For instance, evaluating the signal parameters that are also used as a signal fingerprint makes it possible to infer the transmitting control unit. However, if a deviation in the signal quality occurs in a similar manner in signals from all transmitters, then a problem in the receiver or on the bus line may be inferred.

In addition to the simple analysis of the signal parameters and/or a therefrom obtained signal quality value, it is possible to predict the ageing process of the bus system, that is to say the expected characteristic of the signal changes due to ageing effects or damage, via a model of the electrical and electronic architecture (E/E architecture). Machine learning methods may be used for this purpose such as methods based on Gaussian processes (Gaussian sampling) or reinforcement learning. In conjunction with the measured signal parameters, a learned hybrid model is thereby obtained, which is able to consider the current measured values and allows for a more precise prediction of the ageing processes and the related change in the signal quality.

The model may be used to compare modeled values for the signal parameters with the actually ascertained signal parameter values and thereby makes it possible to detect in a timely manner when the parameters deviate from the modeled values. In the same way, it is possible to infer the causes (i.e. ageing or damage, for instance) of the poor signal quality on the basis of a current network model, in particular when statistical data of many networks or vehicles are available that may be utilized for a comparison and a model update.

FIG. 2 shows an exemplary method according to one exemplary embodiment of the present invention. To begin with, in step 100, a signal parameter value or a plurality of signal parameter values of signals on the bus is/are measured or ascertained from measured data. This may involve the parameters that are regularly ascertained in order to update a fingerprint model and transmitted to a backend, but it is also possible to use additional or other signal parameters.

In step 110, the ascertained signal parameters are transferred to an evaluation unit. This evaluation unit may generally be the same ECU as the measuring unit for measuring the signal parameters or may optionally be connected thereto. In the same way, an evaluation unit could also be connected to the network, i.e. the vehicle bus, for instance. In other cases, the evaluation unit may be a remote processing unit such as a central server or a processing center so that the signal parameters are transmitted via suitable interfaces. Depending on the development, a simple comparison of parameter values may be performed with sufficient speed by a smaller processing unit such as a microcontroller on the bus or, for instance, the fingerprint unit, so that the step may also be omitted if the evaluation is carried out by the same unit that performs the measurement of the parameter values.

In step 120, a combined signal quality value may optionally be generated from the ascertained parameter values. For instance, this value is able to be calculated by a statistical evaluation of the parameters or by a formula that may also be weighted in order to allow for a special consideration of certain signal parameters.

In step 130, it may then be checked whether the signal quality has deteriorated. Toward this end, as already described, the signal parameter values may be examined, individually or in combination, and/or also a signal quality value that was calculated in step 120. All evaluation possibilities are possible, e.g., a specification of threshold values below which the parameter values and/or the signal quality value should not drop. In the same way, the parameters may be evaluated across a longer period of time in a continuous or periodic manner and optionally also be stored for this purpose so that a characteristic of the parameter values or quality values is able to be evaluated, e.g. a marked drop within a short period of time based on an evaluation of the gradient.

Additionally to be used in the evaluation of the signal quality is current model 200 of the network which, for instance, may also take ageing processes into account, e.g., through machine learning, and thereby let a prediction of the expected changes be incorporated as a hybrid model. Expected signal parameters and/or expected signal quality values, for example, are able to be obtained from the model in step 210, which are then also utilized in the evaluation of the signal quality in step 140.

If no relevant ageing effects were identified, then the next measuring and evaluation cycle is started in step 100.

On the other hand, if the signal quality lies below certain threshold values and/or has unexpectedly deteriorated, then the cause may optionally be isolated in step 140 in the already described manner, for instance by comparing fingerprint parameters of the relevant signals using model 200, and the source of the signal be determined in this manner. In the same way, certain previously known error images may be stored in the evaluation unit, which, for instance, are accompanied by a typical manner of a signal deterioration (e.g., frequency interference, breakdowns, etc.), so that the error type is optionally able to be isolated as well.

In step 150, a warning report to the user is then able to be output in the vehicle (or generally in the network and connected components), which is also transmittable to a remote location such as a repair shop, for instance.

The identified features such as the source of the deteriorated or faulty signal or a possible reason for the deteriorated signal (such as a disturbance in the region of the bus line) may also be considered in an error report to be transmitted or stored, so that a repair shop is able to selectively test and possibly exchange corresponding components. In addition, the result of the evaluation may be sent to a central unit, with or without the associated signal parameters, in particular when the signal evaluation has been performed locally. In the process, for example, an identification of the network or the vehicle may be used and all signal data be collected, evaluated and/or classified in this manner in the central unit on a long-term basis in order to update or improve network models and to obtain information about typical ageing manifestations. These data are able to be collectively transmitted after each evaluation or as needed.

The described measures for detecting ageing are able to be used in conjunction with an attack identification on the basis of the specific characteristics or fingerprints, but they may also be used independently of such a purpose, e.g., when more complex methods for identifying the network users are available. In the same way, a certain fingerprint method or a plurality of different fingerprint methods may be used for an attack detection, while partly or completely different signal characteristics are used for monitoring the component ageing.

What is claimed is:

1. A method for detecting a deterioration of network components in a network, the method comprising the following steps:
evaluating, in an evaluation unit, at least one ascertained signal parameter of a signal that is transmitted in a network to determine a signal quality of the signal; and
establishing that a deterioration of the network is present based on the signal quality lying outside a predefined range.

2. The method as recited in claim 1, wherein the evaluation of the at least one signal parameter includes:
obtaining at least one modeled signal parameter from a mathematical network model which at least partly describes transmitted signals in the network;
comparing the at least one ascertained signal parameter with the at least one modeled signal parameter from the network model to determine the signal quality.

3. The method as recited in claim 1, wherein the at least one ascertained signal parameter includes at least one of the following: (i) a clock pulse offset of the signal, (ii) a signal jitter, (iii) an edge steepness of a rising or falling signal edge, (iv) fluctuations in a signal voltage, (v) a frequency component of the signal, (vi) a bit length of a signal.

4. The method as recited in claim 2, wherein the network model (200) includes at least one of the following: (i) a machine learning algorithm, (ii) a neural network, (iii) a stochastic model, (iv) a data-based model.

5. The method as recited in claim 2, further comprising the following step:
adapting the network model based on the at least one ascertained signal parameter.

6. The method as recited in claim 1, further comprising the following steps:
forming a signal quality value based on a plurality of ascertained signal parameters of a signal and/or based on a plurality of ascertained signal parameters of multiple signals from the same source; and
evaluating the signal quality value in order to determine the signal quality of the signal.

7. The method as recited in claim 1, further comprising:
outputting a warning signal when a deterioration of the network is detected; and/or
ascertaining at least one signal parameter of the signal that is transmitted in the network.

8. The method as recited in claim 2, further comprising the following step:
determining, based on the at least one signal parameter and the network model, from which transmitter in the network the signal originates from which the at least one evaluated signal parameter was ascertained.

9. The method as recited in claim 1, further comprising:
evaluating the signal quality of signals from at least two different transmitters in the network.

10. The method as recited in claim 1, further comprising the following step:
statistically evaluating the signal quality of signals in at least two different networks, wherein the networks have at least partly identical network characteristics.

11. The method as recited in claim 10, further comprising the following step:
forming or adapting a prediction model for signals in a network of the networks based on its network characteristics.

12. The method as recited in claim 1, wherein the network includes a Controller Area Network (CAN) bus in a vehicle.

13. A processing unit configured to detect a deterioration of network components in a network, the processing unit configured to:
evaluate, in an evaluation unit, at least one ascertained signal parameter of a signal that is transmitted in a network to determine a signal quality of the signal; and
establish that a deterioration of the network is present based on the signal quality lying outside a predefined range.

14. A non-transitory machine-readable memory medium on which is stored a computer program for detecting a deterioration of network components in a network, the computer program, when executed by a computer, causing the computer to perform:
evaluating, in an evaluation unit, at least one ascertained signal parameter of a signal that is transmitted in a network to determine a signal quality of the signal; and
establishing that a deterioration of the network is present based on the signal quality lying outside a predefined range.
